(19) United States
(12) Patent Application Publication
(10) Pub. No.: US 2019/0172414 A1
(43) Pub. Date: Jun. 6, 2019

(54) DISPLAY APPARATUS INCLUDING IMAGE PROCESSOR, AND IMAGE PROCESSING METHOD

(71) Applicant: Samsung Display Co., Ltd., Yongin-si (KR)

(72) Inventor: Masahiko YOSHIYAMA, Yokohama (JP)

(21) Appl. No.: 16/205,247

(22) Filed: Nov. 30, 2018

(30) Foreign Application Priority Data
Dec. 4, 2017 (KR) 10-2017-0165417

(51) Int. Cl. G09G 5/02; G09G 5/10

(52) U.S. Cl. CPC G09G 5/02; G09G 5/10; G09G 2310/0267; G09G 2310/0275; G09G 2320/066; G09G 2320/0626; G09G 2340/06; G09G 2320/0666; G09G 2360/144; G09G 2310/08

(57) ABSTRACT

An image processor including a color converter converting a first color space of image signals to a second color space having first brightness data, first chrominance data, and second chrominance data, a brightness converter increasing a value of low brightness portion of the first brightness data, to generate second brightness data, a color variation limit unit adjusting the second brightness data with respect to the first chrominance data and the second chrominance data such that an image data converted depending on the second brightness data lie within the first color space, a blend coefficient calculator calculating a blend coefficient depending on an illuminance value, a synthesizer synthesizing the first brightness data with the third brightness data depending on a blend coefficient to generate fourth brightness data, and a signal output unit converting the fourth brightness data, the first chrominance data, and the second chrominance data to output image signals.

### CROSS-REFERENCE TO RELATED APPLICATION

This application claims priority from and the benefit of Korean Patent Application No. 10-2017-0165417, which is hereby incorporated by reference for all purposes as if fully set forth herein.

### BACKGROUND

### Field

Exemplary embodiments of the invention relate generally to an image processor, and more specifically, to a display apparatus including the image processor, and an image processing method.

### Discussion of the Background

In general, a display apparatus includes a display panel including pixels to display an image, a gate driver applying gate signals to the pixels, a data driver applying data voltages to the pixels, and a timing controller controlling an operation of the gate driver and the data driver.

Responsive to the control of the timing controller, the gate driver generates the gate signals, and the data driver generates the data voltages. The pixels receive the data voltages in response to the gate signals and display the image using the data voltages. As brightness of the image displayed through the display panel increases, the contrast ratio in low grayscale deteriorates. As a result, visibility of a dark area in the image is reduced.

The above information disclosed in this Background section is only for understanding of the background of the inventive concepts, and, therefore, it may contain information that does not constitute prior art.

### SUMMARY

Display apparatus constructed according to the principles and exemplary implementations of the invention provide an image processor and image processing method capable of improving the contrast ratio of an image having low brightness to increase visibility of the image on a display.

Additional features of the inventive concepts will be set forth in the description which follows, and in part will be apparent from the description, or may be learned by practice of the inventive concepts.

According to one embodiment of the invention, an image processor includes a color converter to convert a first color space of image signals to a second color space having first brightness data, first chrominance data, and second chrominance data, a brightness converter to increase a value of a low brightness portion of the first brightness data, which is lower than a reference brightness, to generate second brightness data, a color variation limit unit to adjust the second brightness data with respect to the first chrominance data and the second chrominance data such that an image signal converted based on the second brightness data lies within the first color space to generate third brightness data, a blend coefficient calculator to calculate a blend coefficient depending on an illuminance value of an external environment, a synthesizer to synthesize the first brightness data with the third brightness data depending on the blend coefficient to generate fourth brightness data, and a signal output unit to convert the fourth brightness data, the first chrominance data, and the second chrominance data to output the image signals that lie within the first color space.

The first color space may be an RGB color space, the second color space may be a YCoCg color space, the first chrominance data may be chrominance data of orange color, and the second chrominance data may be chrominance data of green color.

The reference brightness may be a brightness value corresponding to 96 grayscale.

The blend coefficient calculator may be configured to calculate that the blend coefficient is 0 when the illuminance value is equal to or smaller than a first reference value and to calculate that the blend coefficient is 1 when the illuminance value is equal to or greater than a second reference value, and the second reference value is greater than the first reference value.

The blend coefficient calculator may be configured to calculate that the blend coefficient gradually increases between a value greater than 0 and a value smaller than 1 in accordance with an increase in the illuminance value when the illuminance value is smaller than the second reference value and greater than the first reference value.

The first reference value may be set to about 1,000 Lux, and the second reference value is set to about 3,000 Lux.

A synthesis ratio of the third brightness data may increase as the illuminance value increases between the first reference value and the second value.

The synthesizer may be configure to synthesize the first brightness data with the third brightness data to generate the fourth brightness data, according to the following Equation of: Y3=Y2×α+Y0×(1−α), wherein Y0 denotes the first brightness data, Y2 denotes the third brightness data, Y3 denotes the fourth brightness data, and α denotes the blend coefficient.

According to another embodiment of the invention, an image processing method includes converting a first color space of image signals to a second color space having first brightness data, first chrominance data, and second chrominance data, increasing a value of a low brightness portion of the first brightness data, which is lower than a reference brightness, to generate second brightness data, adjusting the second brightness data with respect to the first chrominance data and the second chrominance data such that an image signal converted depending on the second brightness data lie within the first color space to generate third brightness data, calculating a blend coefficient depending on an illuminance value of an external environment, synthesizing the first brightness data with the third brightness data depending on the blend coefficient to generate fourth brightness data, and converting the fourth brightness data, the first chrominance data, and the second chrominance data to output image signals that lie within the first color space.

The first color space may be an RGB color space, the second color space may be a YCoCg color space, the first chrominance data may be chrominance data of orange color, and the second chrominance data may be chrominance data of green color.

The reference brightness may be a brightness value corresponding to 96 grayscale.

The step of calculating of the blend coefficient may include calculating that the blend coefficient is 0 when the illuminance value is equal to or smaller than a first reference value and calculating that the blend coefficient is 1 when the illuminance value is equal to or greater than a second reference value, and the second reference value is greater than the first reference value.

The step of calculating of the blend coefficient calculator may further include calculating that the blend coefficient gradually increases between a value greater than 0 and a value smaller than 1 in accordance with an increase in the illuminance value when the illuminance value is smaller than the second reference value and greater than the first reference value.

The first reference value may be set to about 1,000 Lux, and the second reference value is set to about 3,000 Lux.

A synthesis ratio of the third brightness data may increase as the illuminance value increases between the first reference value and the second value.

The first brightness data with the third brightness data may be synthesized with each other to generate the fourth brightness data, according to the following Equation of: Y3=Y2×α+Y0×(1−α), wherein Y0 denotes the first brightness data, Y2 denotes the third brightness data, Y3 denotes the fourth brightness data, and α denotes the blend coefficient.

According to another embodiment of the invention, a display apparatus includes a display panel including a plurality of pixels, a gate driver to apply a plurality of gate signals to the plurality of pixels, a data driver to apply a plurality of data voltages corresponding to image signals to the pixels, and a timing controller including an image processor to convert a data format of the image signals, to apply the image signals to the data driver as the image data, and to increase a value of low brightness data of the image signals depending on an illuminance value of an external environment to generate output image signals from the image signals. The image processor includes a color converter to convert a first color space of the image signals to a second color space having first brightness data, first chrominance data, and second chrominance data, a brightness converter to increase a value of a low brightness portion of the first brightness data, which is lower than a reference brightness, to generate second brightness data, a color variation limit unit to adjust the second brightness data with respect to the first chrominance data and the second chrominance data such that an image data converted depending on the second brightness data lie within the first color space to generate third brightness data, a blend coefficient calculator to calculate a blend coefficient depending on an illuminance value of an external environment, a synthesizer to synthesize the first brightness data with the third brightness data depending on the blend coefficient to generate fourth brightness data, and a signal output unit to convert the fourth brightness data, the first chrominance data, and the second chrominance data to the output image signals that lie within the first color space.

The blend coefficient calculator may be configured to calculate that the blend coefficient is 0 when the illuminance value is equal to or smaller than a first reference value and to calculate that the blend coefficient is 1 when the illuminance value is equal to or greater than a second reference value, and the second reference value is greater than the first reference value.

The blend coefficient calculator may be configured to calculate that the blend coefficient gradually increases between a value greater than 0 and a value smaller than 1 in accordance with an increase in the illuminance value when the illuminance value is smaller than the second reference value and greater than the first reference value.

The synthesizer may be configure to synthesize the first brightness data with the third brightness data to generate the fourth brightness data, according to the following Equation of: Y3=Y2×α+Y0×(1−α), wherein Y0 denotes the first brightness data, Y2 denotes the third brightness data, Y3 denotes the fourth brightness data, and α denotes the blend coefficient.

According to the above, the low grayscale value increases. Thus, the contrast ratio of the image having the low brightness may be improved, and the visibility of the image may be improved.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the inventive concepts.

FIG. 1 is a block diagram showing an exemplary embodiment of an image processor constructed according to the principles of the invention;

FIG. 2 is an exemplary graph useful in explaining an operation of a brightness converter shown in FIG. 1;

FIG. 3 is an exemplary graph showing an RGB color space;

FIG. 4 is an exemplary graph showing the correlation between brightness and grayscale depending on external illuminance values;

FIG. 5 is a flowchart showing an image processing method according to an exemplary embodiment of the invention;

FIG. 6 is an exemplary graph useful in explaining an operation of a brightness converter of an image processor constructed according to another exemplary embodiment of the invention; and

FIG. 7 is a block diagram showing an exemplary embodiment of a display apparatus including the image processor shown in FIG. 1 constructed according to the principles of the invention.

### DETAILED DESCRIPTION

In the following description, for the purposes of explanation, numerous specific details are set forth in order to provide a thorough understanding of various exemplary embodiments or implementations of the invention. As used herein “embodiments” and “implementations” are interchangeable words that are non-limiting examples of devices or methods employing one or more of the inventive concepts disclosed herein. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments. Further, various exemplary embodiments may be different, but do not have to be exclusive. For example, specific shapes, configurations, and characteristics of an exemplary embodiment may be used or implemented in another exemplary embodiment without departing from the inventive concepts.

Unless otherwise specified, the illustrated exemplary embodiments are to be understood as providing exemplary features of varying detail of some ways in which the inventive concepts may be implemented in practice. Therefore, unless otherwise specified, the features, components, modules, layers, films, panels, regions, and/or aspects, etc. (hereinafter individually or collectively referred to as “elements”), of the various embodiments may be otherwise combined, separated, interchanged, and/or rearranged without departing from the inventive concepts.

The use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, etc., of the elements, unless specified. Further, in the accompanying drawings, the size and relative sizes of elements may be exaggerated for clarity and/or descriptive purposes. When an exemplary embodiment may be implemented differently, a specific process order may be performed differently from the described order. For example, two consecutively described processes may be performed substantially at the same time or performed in an order opposite to the described order. Also, like reference numerals denote like elements.

When an element, such as a layer, is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. To this end, the term “connected” may refer to physical, electrical, and/or fluid connection, with or without intervening elements. Further, the D1-axis, the D2-axis, and the D3-axis are not limited to three axes of a rectangular coordinate system, such as the x, y, and z-axes, and may be interpreted in a broader sense. For example, the D1-axis, the D2-axis, and the D3-axis may be perpendicular to one another, or may represent different directions that are not perpendicular to one another. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. As used herein, the term “and/or” includes any and all combinations of one or more of the associated listed items.

Although the terms “first,” “second,” etc. may be used herein to describe various types of elements, these elements should not be limited by these terms. These terms are used to distinguish one element from another element. Thus, a first element discussed below could be termed a second element without departing from the teachings of the disclosure.

Spatially relative terms, such as “beneath,” “below,” “under,” “lower,” “above,” “upper,” “over,” “higher,” “side” (e.g., as in “sidewall”), and the like, may be used herein for descriptive purposes, and, thereby, to describe one elements relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art. As customary in the field, some exemplary embodiments are described and illustrated in the accompanying drawings in terms of functional blocks, units, and/or modules. Those skilled in the art will appreciate that these blocks, units, and/or modules are physically implemented by electronic (or optical) circuits, such as logic circuits, discrete components, microprocessors, hard-wired circuits, memory elements, wiring connections, and the like, which may be formed using semiconductor-based fabrication techniques or other manufacturing technologies. In the case of the blocks, units, and/or modules being implemented by microprocessors or other similar hardware, they may be programmed and controlled using software (e.g., microcode) to perform various functions discussed herein and may optionally be driven by firmware and/or software. It is also contemplated that each block, unit, and/or module may be implemented by dedicated hardware, or as a combination of dedicated hardware to perform some functions and a processor (e.g., one or more programmed microprocessors and associated circuitry) to perform other functions. Also, each block, unit, and/or module of some exemplary embodiments may be physically separated into two or more interacting and discrete blocks, units, and/or modules without departing from the scope of the inventive concepts. Further, the blocks, units, and/or modules of some exemplary embodiments may be physically combined into more complex blocks, units, and/or modules without departing from the scope of the inventive concepts. Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and should not be interpreted in an idealized or overly formal sense, unless expressly so defined herein.

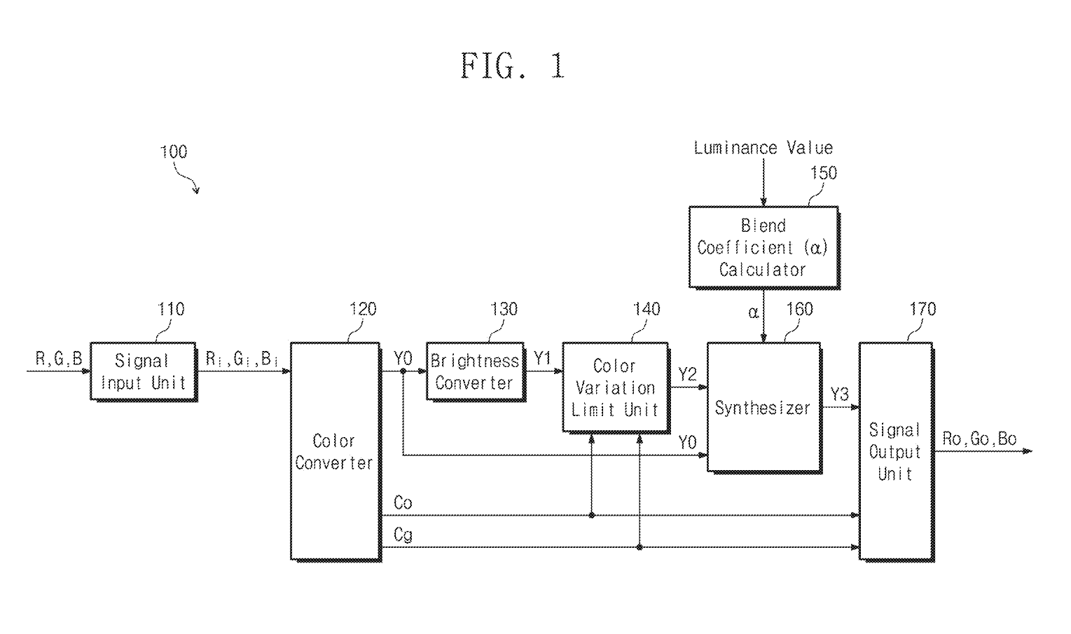

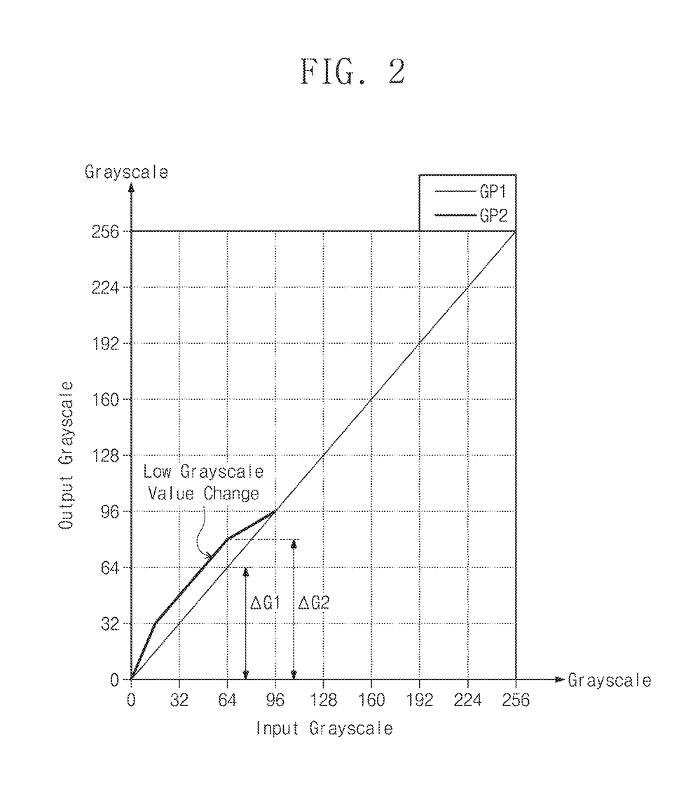

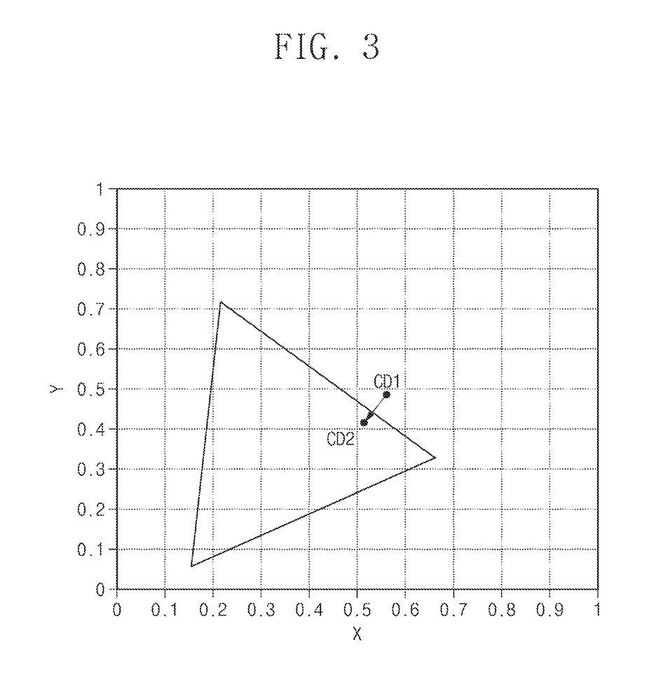

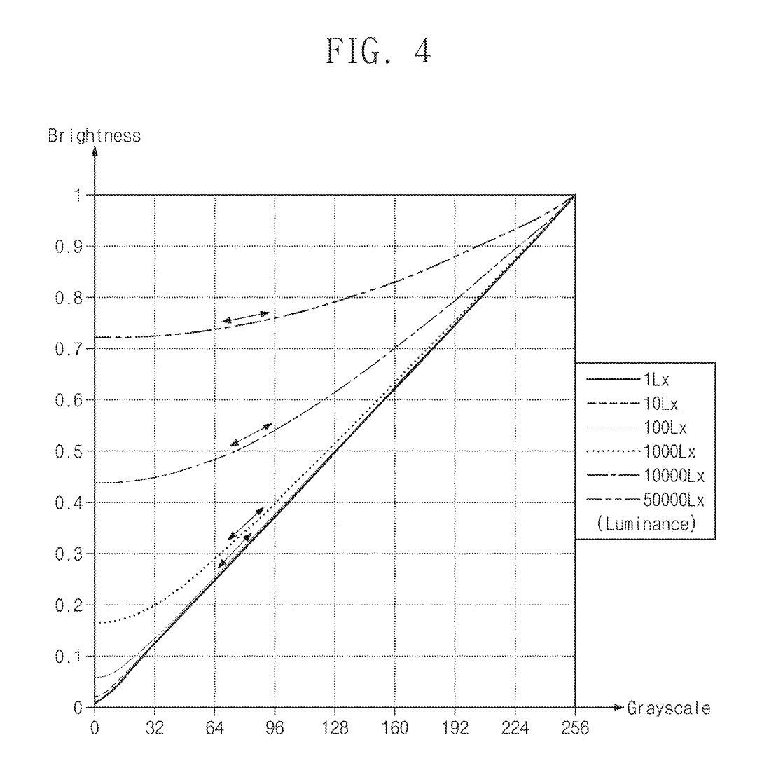

FIG. 1 is a block diagram showing an exemplary embodiment of image processor 100 constructed according to the principles of the invention. FIG. 2 is an exemplary graph explaining an operation of a brightness converter 130 shown in FIG. 1. FIG. 3 is an exemplary graph showing an RGB color space (or a “color gamut”). FIG. 4 is an exemplary graph showing the correlation between brightness and grayscale depending on external illuminance values.

Referring to FIGS. 1 to 4, the image processor 100 includes a signal input unit 110, a color converter 120, a brightness converter 130, a color variation limit unit 140, a blend coefficient (a) calculator 150, a synthesizer 160, and a signal output unit 170.

The signal input unit 110 receives image signals R, G, and B of the RGB color space. The image signals R, G, and B each have a non-linear characteristic. The signal input unit 110 applies a gamma function to the image signals R, G, and B having non-linear characteristics to linearize the image signals R, G, and B. The linearized image signals Ri, Gi, and Bi are applied to the color converter 120.

The color converter 120 converts a first color space defined as the RGB color space to a second color space defined as a YCoCg color space. As an example, the color converter 120 converts an RGB format (or RGB color space) of the linearized image signals Ri, Gi, and Bi to a YCoCg format (or YCoCg color space). The YCoCg format indicates a data format in which brightness data are separated from chrominance data. The “Y” denotes the brightness data, the “Co” denotes the chrominance data of orange color as first chrominance data, and the “Cg” denotes the chrominance data of green color as second chrominance data.

The image signals Ri, Gi, and Bi include red image data Ri, green image data Gi, and blue image data Bi. The color converter 120 converts the red image data Ri, the green image data Gi, and the blue image data Bi to brightness data Y0, the orange chrominance data Co, and the green chrominance data Cg.

The brightness data Y0 generated by the color converter 120 is provided to the brightness converter 130 as first brightness data Y0. The orange chrominance data Co and the green chrominance data Cg, which are generated by the color converter 120, are provided to the color variation limit unit 140 and the signal output unit 170.

The brightness converter 130 increases a low brightness portion in the first brightness data Y0 to change the first brightness data Y0. As an example, the brightness converter 130 increases a value of low brightness data lower than a predetermined reference brightness in the first brightness data Y0 to generate second brightness data Y1. The brightness converter 130 provides the second brightness data Y1 to the color variation limit unit 140.

As shown in FIG. 2, the linearized image signals Ri, Gi, and Bi have a grayscale characteristic in which an output grayscale with respect to an input grayscale has a linearized value as represented by a first graph GP1. That is, an output grayscale value is determined in proportion to an input grayscale value. Since the brightness converter 130 increases the grayscale portion at low input values (“low grayscale portion”), the low grayscale value increases. As the low grayscale value is changed, the value of the output grayscale with respect to the input grayscale increases at the low brightness levels.

As a representative example, a reference brightness may be set to a brightness value corresponding to 96 grayscale in FIG. 2. Accordingly, low brightness may be a brightness corresponding to grayscales lower than the 96 grayscale. As an exemplary range, when the input grayscale is in a range of 0 to 64 grayscales, the output grayscale is increased in a range of 0 to 80 grayscales (ΔG2) from the range of 0 to 64 grayscales (ΔG1). When the grayscale range is increased, the brightness range is increased, and as a result, the contrast ratio of an image having low brightness may be improved.

The color variation limit unit 140 receives the second brightness data Y1, the orange chrominance data Co, and the green chrominance data Cg. When the YCoCg color space is converted to the RGB color space again, the image data may lie outside the RGB color space.

As shown in FIG. 3, when the YCoCg data are converted to the image data of the RGB color space again, the first color data CD1 may lie outside the RGB color space. As an example, when the YCoCg data obtained by combining the second brightness data Y1, the orange chrominance data Co, and the green chrominance data Cg are converted to the image data of the RGB color space, the image data converted in accordance with the second brightness data Y1 may lie outside the RGB color space as shown at the first color data CD1.

Although the YCoCg color space is converted to the RGB color space again, the color variation limit unit 140 may limit the second brightness data Y1 with respect to the orange chrominance data Co and the green chrominance data Cg such that the image data converted in accordance with the second brightness data Y1 lie inside the RGB color space. As an example, the color variation limit unit 140 controls the second brightness data Y1 such that the first color data CD1 is converted to second color data CD2, which lies inside the RGB color space, and thus third brightness data Y2 may be generated.

The color variation limit unit 140 provides the third brightness data Y2 to the synthesizer 160. The synthesizer 160 receives the first brightness data Y0 and the third brightness data Y2 and receives a blend coefficient (a) from the blend coefficient (a) calculator 150.

The blend coefficient (a) calculator 150 receives an illuminance value of external environment, such as ambient light conditions. The blend coefficient (a) calculator 150 calculates the blend coefficient (a) depending on the illuminance value and provides the calculated blend coefficient (a) to the synthesizer 160. Hereinafter, the blend coefficient (a) calculation operation of the blend coefficient (a) calculator 150 will be described in detail with reference to FIG. 4.

In FIG. 4, the horizontal axis indicates a grayscale value, and the vertical axis indicates a brightness value. The unit of the external illuminance values is Lux. The brightness value “1” indicates the brightness of about 100%, and brightnesses corresponding to grayscale values of 0 to 256 are relatively shown in FIG. 4.

As shown in FIG. 4, as the external illuminance values increase, the brightness values increase. In addition, as the external illuminance values decrease, a variation (bidirectional arrow) in brightness depending on the grayscale value increases, and as the external illuminance values increase, the variation in brightness depending on the grayscale value decreases. In particular, the variation in brightness is significant at the low grayscale. As the external illuminance value increases in the low grayscale, the brightness value increases, and the variation of the brightness value decreases. Accordingly, as the external illuminance value increases in the low grayscale, the contrast ratio decreases.

The blend coefficient (a) calculator 150 calculates different blend coefficients (a) depending on the illuminance values. As an example, the blend coefficient (a) calculator 150 calculates that the blend coefficient (a) is zero (0) when the illuminance value is equal to or smaller than a first reference value. The blend coefficient (a) calculator 150 calculates that the blend coefficient (a) is 1 when the illuminance value is equal to or greater than a second reference value, which is greater than the first reference value.

The blend coefficient (a) calculator 150 calculates that the blend coefficient (a) gradually increases between a value greater than zero (0) and a value smaller than 1 in accordance with an increase in the illuminance value when the illuminance value is smaller than the second reference value and greater than the first reference value. The first reference value has about 1,000 Lux, and the second reference value has about 3,000 Lux.

In order to increase the contrast ratio in low brightness conditions, the blend coefficient (α) calculator 150 sets the blend coefficient (α) to be relatively high as the illuminance value increases and maintains the blend coefficient (α) at a maximum value when the illuminance value is equal to or greater than the second reference value. The blend coefficient (α) calculator 150 maintains the blend coefficient (α) at a minimum value when the illuminance value is equal to or smaller than the first reference value, which does not require adjustment of the contrast ratio.

As an example, when the illuminance value is about 10,000 Lux in FIG. 4, the brightness variation in a low brightness area corresponding to the low grayscale is small, and thus the blend coefficient (α) calculator 150 sets the blend coefficient (α) to 1. When the illuminance value is about 1, 10, or 100 Lux in FIG. 4, the brightness variation in the low brightness area corresponding to the low grayscale in each illuminance value is great, and thus the blend coefficient (α) calculator 150 sets the blend coefficient (α) to 0.

The synthesizer 160 receives the blend coefficient (α) and synthesizes the first brightness data Y0 and the third brightness data Y2 in accordance with the blend coefficient (α). The synthesizer 160 synthesizes the first brightness data Y0 and the third brightness data Y2 according to the following Equation 1 to generate fourth brightness data Y3.

Y3=Y2×α+Y0×(1−α) Equation 1:

The range of the low brightness is expanded by the third brightness data Y2, and thus the contrast ratio increases. According to Equation 1, since the blend coefficient (α) increases as the illuminance value becomes higher, the synthesis ratio of the third brightness data Y2 increases. That is, as the illuminance value becomes higher between the first reference value and the second reference value, the synthesis ratio of the third brightness data Y2 increases. As a result, the contrast ratio of the low brightness corresponding to the low grayscale becomes higher.

In the case where the illuminance value is equal to or smaller than the first reference value, the blend coefficient (α) becomes zero (0), and thus the third brightness data Y2 becomes zero (0). That is, in the case where the illuminance value is equal to or smaller than the first reference value that does not require adjustment of the contrast ratio, the third brightness data Y2 is not synthesized with the first brightness data Y0. Although the brightness converter 130 adjusts the brightness value, the third brightness data Y2, which is the controlled brightness value, is synthesized with the first brightness data Y0, which is the original brightness value, at a predetermined rate (blend coefficient (α)) when the contrast ratio of the low brightness needs to be increased by taking into account the illuminance values.

The fourth brightness data Y3 generated by the synthesizer 160 is provided to the signal output unit 170. The signal output unit 170 converts the fourth brightness data Y3, the chrominance data of orange color Co, the chrominance data of green color Cg to output image signals of the RGB color space and performs a reverse gamma correction on the output image signals. The signal output unit 170 outputs the output image signals Ro, Go, and Bo on which the reverse gamma correction is performed.

Consequently, the image processor 100 according to exemplary embodiments of the invention may improve the contrast ratio of a low brightness image, and thus the visibility of the image may be improved.

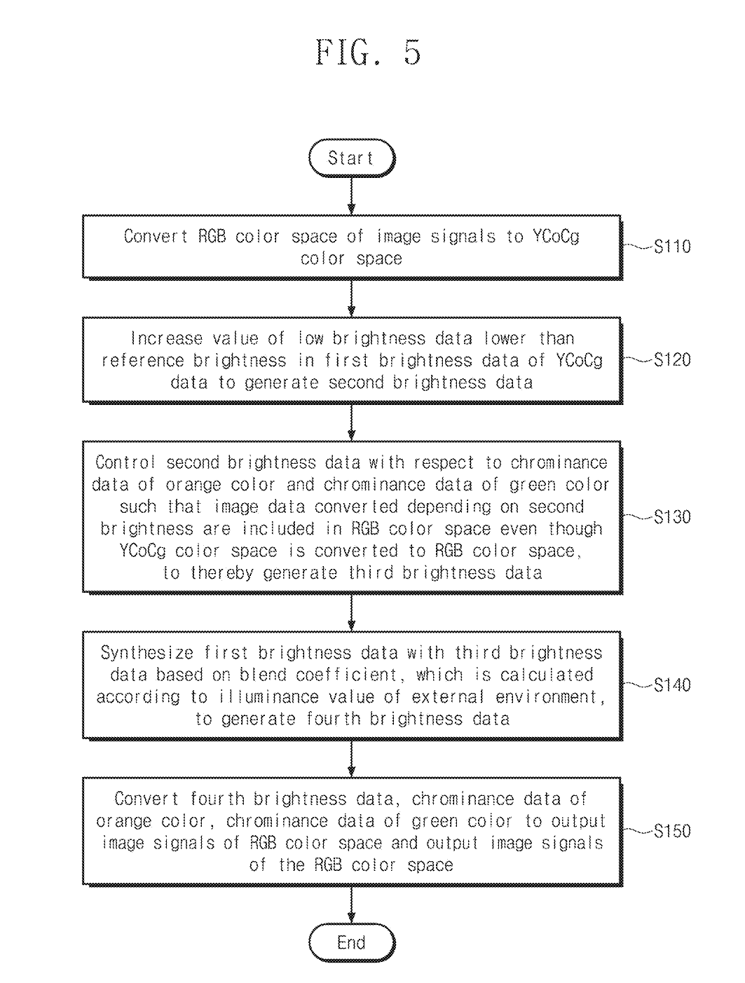

FIG. 5 is a flowchart showing an image processing method according to an exemplary embodiment of the invention.

Referring to FIG. 5, the RGB color space of the image signals Ri, Gi, and Bi is converted to the YCoCg color space in operation S110. Accordingly, the image signals Ri, Gi, and Bi are converted to the first brightness data Y0, the chrominance data of orange color Co, and the chrominance data of green color Cg. The image signals Ri, Gi, and Bi are image signals obtained by gamma-correcting and linearizing the image signals R, G, and B.

In operation S120, the value of the low brightness data lower than the reference brightness in the first brightness data Y0 of the YCoCg data converted to the YCoCg color space increases to generate the second brightness data Y1. In operation S130, the second brightness data Y1 with respect to the chrominance data of orange color Co and the chrominance data of green color Cg are controlled such that the image data converted in accordance with the second brightness Y1 are included in the RGB color space even though the YCoCg color space is converted to the RGB color space again, to thereby generate the third brightness data Y2.

In operation S140, the first brightness data Y0 and the third brightness data Y2 are synthesized with each other based on the blend coefficient (α), which is calculated according to the illuminance value of the external environment, to generate the fourth brightness data Y3. As described above, when the illuminance value is equal to or smaller than the first reference value, the blend coefficient (α) is calculated as zero (0), and when the illuminance value is equal to or greater than the second reference value, the blend coefficient (α) is calculated as 1. When the illuminance value is smaller than the second reference value and greater than the first reference value, the blend coefficient (α), which gradually increases between a value greater than zero (0) and a value smaller than 1 in accordance with the increase in the illuminance value, may be calculated.

The fourth brightness data Y3 is generated by synthesizing the first brightness data Y0 with the third brightness data Y2 as represented by Equation 1. Accordingly, although the brightness value is adjusted, the third brightness data Y2, which is the controlled brightness value, is synthesized with the first brightness data Y0, which is the original brightness value, at the predetermined rate (blend coefficient (α)) when the contrast ratio of the low brightness needs to be increased by taking into account the illuminance values.

In operation S150, the fourth brightness data Y3, the chrominance data of orange color Co, the chrominance data of green color Cg are converted to the output image signals of the RGB color space. In this case, the reverse gamma correction is performed on the output image signals, and the output image signals Ro, Go, and Bo on which the reverse gamma correction is performed are output.

Consequently, image processing methods according to exemplary embodiments of the invention may improve the contrast ratio of the low brightness image, and thus the visibility of the image may be improved.

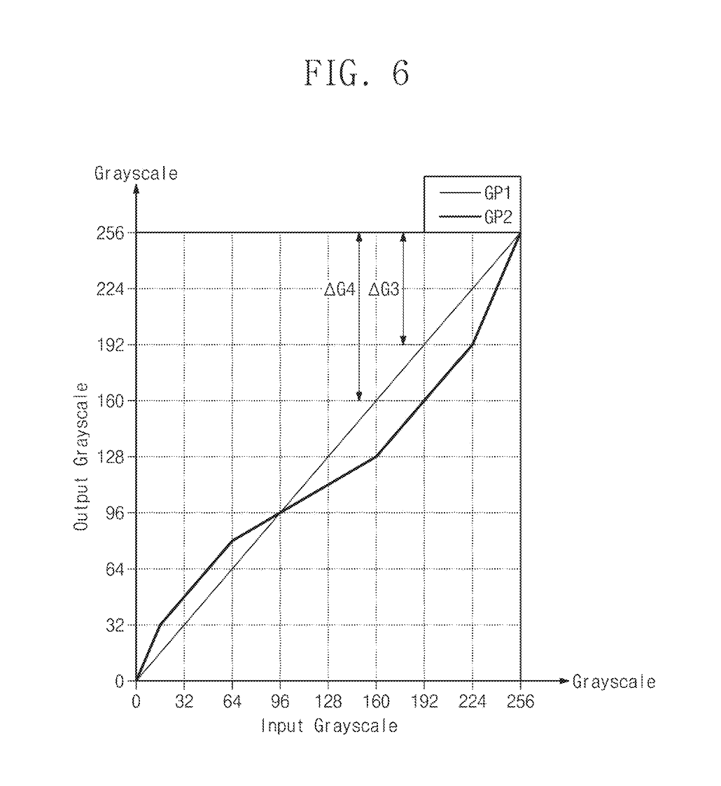

FIG. 6 is a an exemplary graph useful in explaining an operation of a brightness converter of an image processor constructed according to another exemplary embodiment of the invention.

In this exemplary embodiment, the image processor has substantially the same structure and function as the image processor shown in FIG. 1 except for the brightness converter.

Referring to FIG. 6, the brightness converter according to the illustrated exemplary embodiment increases a value of low brightness data lower than a predetermined reference brightness of the first brightness data Y0 as the brightness converter 130 shown in FIG. 1. Additionally, the brightness converter according to the this exemplary embodiment decreases a value of high brightness data higher than the predetermined reference brightness of the first brightness data Y0.

As an exemplary range, when the input grayscale is in a range of 192 to 256 grayscales, the output grayscale is increased to a range of 160 to 256 grayscales (ΔG4) from the range of 192 to 256 grayscales (ΔG3). When the grayscale range is increased, the brightness range is increased, and as a result, the contrast ratio of an image having high brightness may be improved. Since other operations are substantially the same as those of the brightness converter 130, details thereof will be omitted to avoid redundancy.

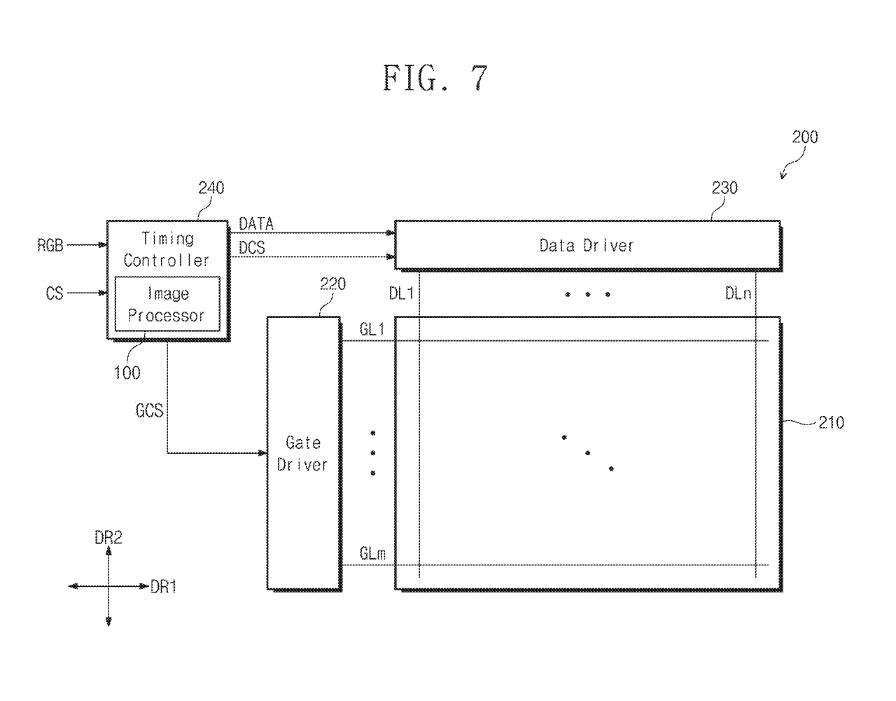

FIG. 7 is a block diagram showing an exemplary embodiment of a display apparatus 200 including the image processor shown in FIG. 1 constructed according to the principles of the invention.

Referring to FIG. 7, the display apparatus 200 according to the illustrated embodiment includes a display panel 210, a gate driver 220, a data driver 230, and a timing controller 240. The display panel 210 may be any type of display panel know in the art, including but not limited to, a liquid crystal display panel having a liquid crystal layer, an electrophoretic display panel having an electrophoretic layer, an electrowetting display panel having an electrowetting layer, or an organic light emitting display panel having an organic light emitting layer.

The display panel 210 includes a plurality of gate lines GL1 to GLm, a plurality of data lines DL1 to DLn, and a plurality of pixels PX. Each of “m” and “n” is a natural number. The gate lines GL1 to GLm are insulated from the data lines DL1 to DLn while intersecting the data lines DL1 to DLn. The gate lines DL1 to DLm extend in a first direction DR1 and are connected to the gate driver 220. The data lines DL1 to DLn extend in a second direction DR2 and are connected to the data driver 230.

The pixels PX are arranged in areas defined by the gate lines GL1 to GLm and the data lines DL1 to DLn intersecting the gate lines GL1 to GLm. The pixels PX are arranged in a matrix form and connected to the gate lines GL1 to GLm and the data lines DL1 to DLn. Each of the pixels PX displays one of primary colors. The primary colors may be include red, green, and blue colors, but are not limited thereto or thereby. That is, the primary colors further include white, yellow, cyan, and magenta colors.

The timing controller 240 receives a plurality of image signals R, G, and B used to display an image and control signals CS used to control an operation of the gate driver 220 and the data driver 230 from an external source (e.g., a system board).

The timing controller 240 converts a data format of the image signals R, G, and B to a data format appropriate to an interface between the timing controller 240 and the data driver 230. The timing controller 240 provides the image signals R, G, and B having the converted data format to the data driver 230 as image data DATA.

The timing controller 240 includes the image processor 100 shown in FIG. 1, but the image processor shown in FIG. 6 could also be used. The image processor 100 increases the value of the low brightness data of the image signals R, G, and B depending on the external illuminance value to generate the output image signals Ro, Go, and Bo. Since configurations of the image processor 100 have been described in detail above, detailed descriptions of the image processor 100 will be omitted to avoid redundancy. The timing controller 240 converts a data format of the output image signals Ro, Go, and Bo to a data format appropriate to the interface between the data driver 230 and the timing controller 240 and outputs the output image signals Ro, Go, and Bo having the converted data format as the image data DATA.

The timing controller 240 generates a gate control signal GCS and a data control signal DCS in response to the control signals CS. The gate control signal GCS is provided to the gate driver 220 as a control signal to control an operation timing of the gate driver 220. The data control signal DCS is provided to the data driver 230 as a control signal to control an operation timing of the data driver 230.

The gate driver 220 receives the gate control signal GCS from the timing controller 240 and generates a plurality of gate signals in response to the gate control signal GCS. The gate signals are sequentially output and applied to the pixels PX, which are arranged in the unit of row, through the gate lines GL1 to GLm.

The data driver 230 receives the image data DATA and the data control signal DCS from the timing controller 240. The data driver 230 generates data voltages in analog form, which correspond to the image data DATA, in response to the data control signal DCS and outputs the data voltages. The data voltages are applied to the pixels PX through the data lines DL1 to DLn. The pixels PX receive the data voltages in response to the gate signals. The pixels PX are driven in response to the data voltages to display the image.

Some of the advantages that may be achieved by exemplary embodiments and exemplary methods of the invention include improving the contrast ratio of an image having a low brightness and/or a high brightness, thereby improving the visibility of the image on the display.

Although certain exemplary embodiments and implementations have been described herein, other embodiments and modifications will be apparent from this description. Accordingly, the inventive concepts are not limited to such embodiments, but rather to the broader scope of the appended claims and various obvious modifications and equivalent arrangements as would be apparent to a person of ordinary skill in the art.

What is claimed is:

1. An image processor comprising:
a color converter to convert a first color space of image signals to a second color space having first brightness data, first chrominance data, and second chrominance data;
a brightness converter to increase a value of a low brightness portion of the first brightness data, which is lower than a reference brightness, to generate second brightness data;
a color variation limit unit to adjust the second brightness data with respect to the first chrominance data and the second chrominance data such that an image signal converted based on the second brightness data lies within the first color space to generate third brightness data;
a blend coefficient calculator to calculate a blend coefficient depending on an illuminance value of an external environment;
a synthesizer to synthesize the first brightness data with the third brightness data depending on the blend coefficient to generate fourth brightness data; and
a signal output unit to convert the fourth brightness data, the first chrominance data, and the second chrominance data to output image signals that lie within the first color space.

2. The image processor of claim 1, wherein the first color space is an RGB color space, the second color space is a YCoCg color space, the first chrominance data is chrominance data of orange color, and the second chrominance data is chrominance data of green color.

3. The image processor of claim 1, wherein the reference brightness is a brightness value corresponding to 96 grayscale.

4. The image processor of claim 1, wherein the blend coefficient calculator is configured to calculate that the blend coefficient is 0 when the illuminance value is equal to or smaller than a first reference value, and to calculate that the blend coefficient is 1 when the illuminance value is equal to or greater than a second reference, wherein the second reference value is greater than the first reference value.

5. The image processor of claim 4, wherein the blend coefficient calculator is configured to calculate that the blend coefficient gradually increases between a value greater than 0 and a value smaller than 1 in accordance with an increase in the illuminance value when the illuminance value is smaller than the second reference value and greater than the first reference value.

6. The image processor of claim 4, wherein the first reference value is set to about 1,000 Lux, and the second reference value is set to about 3,000 Lux.

7. The image processor of claim 4, wherein a synthesis ratio of the third brightness data increases as the illuminance value increases between the first reference value and the second value.

8. The image processor of claim 7, wherein the synthesizer is configure to synthesize the first brightness data with the third brightness data to generate the fourth brightness data, according to the following Equation of: Y3=Y2×α+Y0×(1−α),
wherein Y0 denotes the first brightness data, Y2 denotes the third brightness data, Y3 denotes the fourth brightness data, and α denotes the blend coefficient.

9. An image processing method comprising the steps of:
converting a first color space of image signals to a second color space having first brightness data, first chrominance data, and second chrominance data;
increasing a value of a low brightness portion of the first brightness data, which is lower than a reference brightness, to generate second brightness data;
adjusting the second brightness data with respect to the first chrominance data and the second chrominance data such that an image signal converted depending on the second brightness data lie within the first color space to generate third brightness data;
calculating a blend coefficient depending on an illuminance value of an external environment;
synthesizing the first brightness data with the third brightness data depending on the blend coefficient to generate fourth brightness data; and
converting the fourth brightness data, the first chrominance data, and the second chrominance data to output image signals that lie within the first color space.

10. The image processing method of claim 9, wherein the first color space is an RGB color space, the second color space is a YCoCg color space, the first chrominance data is chrominance data of orange color, and the second chrominance data is chrominance data of green color.

11. The image processing method of claim 9, wherein the reference brightness is a brightness value corresponding to 96 grayscale.

12. The image processing method of claim 9, wherein the step of calculating of the blend coefficient comprises calculating that the blend coefficient is 0 when the illuminance value is equal to or smaller than a first reference value and calculating that the blend coefficient is 1 when the illuminance value is equal to or greater than a second reference value greater than the first reference value.

13. The image processing method of claim 12, wherein the step of calculating of the blend coefficient further comprises calculating that the blend coefficient gradually increases between a value greater than 0 and a value smaller than 1 in accordance with an increase in the illuminance value when the illuminance value is smaller than the second reference value and greater than the first reference value.

14. The image processing method of claim 12, wherein the first reference value is set to about 1,000 Lux, and the second reference value is set to about 3,000 Lux.

15. The image processing method of claim 12, wherein a synthesis ratio of the third brightness data increases as the illuminance value increases between the first reference value and the second value.

16. The image processing method of claim 15, wherein the first brightness data and the third brightness data are synthesized with each other to generate the fourth brightness data, according to the following Equation of Y3=Y2×α+Y0×(1−α),
wherein Y0 denotes the first brightness data, Y2 denotes the third brightness data, Y3 denotes the fourth brightness data, and α denotes the blend coefficient.

17. A display apparatus comprising:
a display panel having a plurality of pixels;
a gate driver to apply a plurality of gate signals to the plurality of pixels;
a data driver to apply a plurality of data voltages corresponding to image signals to the pixels; and
a timing controller including an image processor to convert a data format of the image signals, to apply the image signals to the data driver as the image data, and to increase a value of low brightness data of the image signals depending on an illuminance value of an external environment to generate output image signals from the image signals, the image processor comprising:
a color converter to convert a first color space of the image signals to a second color space having first brightness data, first chrominance data, and second chrominance data;
a brightness converter to increase a value of a low brightness portion of the first brightness data, which is lower than a reference brightness, to generate second brightness data;
a color variation limit unit to adjust the second brightness data with respect to the first chrominance data and the second chrominance data such that image data converted depending on the second brightness data lie within the first color space to generate third brightness data;
a blend coefficient calculator to calculate a blend coefficient depending on an illuminance value of an external environment;
a synthesizer to synthesize the first brightness data with the third brightness data depending on the blend coefficient to generate fourth brightness data; and
a signal output unit to convert the fourth brightness data, the first chrominance data, and the second chrominance data to the output image signals that lie within the first color space.

18. The display apparatus of claim 17, wherein the blend coefficient calculator is configured to calculate that the blend coefficient is 0 when the illuminance value is equal to or smaller than a first reference value and calculates that the blend coefficient is 1 when the illuminance value is equal to or greater than a second reference value greater than the first reference value.

19. The display apparatus of claim 18, wherein the blend coefficient calculator is configured to calculate that the blend coefficient gradually increases between a value greater than 0 and a value smaller than 1 in accordance with an increase in the illuminance value when the illuminance value is smaller than the second reference value and greater than the first reference value.

20. The display apparatus of claim 17, wherein the synthesizer is configured to synthesize the first brightness data with the third brightness data to generate the fourth brightness data, according to the following Equation of Y3=Y2×α+Y0×(1−α),
wherein Y0 denotes the first brightness data, Y2 denotes the third brightness data, Y3 denotes the fourth brightness data, and α denotes the blend coefficient.
